(19) United States
(12) Patent Application Publication
(10) Pub. No.: US 2013/0086023 A1
(43) Pub. Date: Apr. 4, 2013

(54) CONTENT PROCESSING EXECUTION DEVICE, CONTENT PROCESSING EXECUTION METHOD, AND PROGRAMME

(71) Applicant: Yoshihiro Tsukamoto, Kanagawa (JP)

(72) Inventor: Yoshihiro Tsukamoto, Kanagawa (JP)

(73) Assignee: PANASONIC CORPORATION, Osaka (JP)

(21) Appl. No.: 13/703,697

(22) PCT Filed: Apr. 14, 2011
(86) PCT No.: PCT/JP2011/002211

§ 371 Date: Dec. 12, 2012

(30) Foreign Application Priority Data
Jun. 15, 2010 (JP) 2010-136617

(51) Int. Cl. G06F 17/30

(52) U.S. Cl. CPC G06F 17/30386
USPC 707/705

(57) ABSTRACT

A content processing execution device receives an instruction of a processing execution of content, and acquires operation history information of the content corresponding to the instruction from an operation history information storage unit. The operation history information storage unit stores operation history information associated with an operation date and time of the content, an operation substance of the content, and an operation party of the content in accordance with the instruction of processing execution of the input content. Then, the content processing execution device acquires a life log corresponding to the operation substance of the operation history information from a life log storage unit that stores a life log corresponding to an operation substance of operation history information of the content based on the acquired operation history information; and present the acquired life log when the processing of the content is executed.

### TECHNICAL FIELD

The present invention relates to a content processing execution device, a content processing execution method, and a programme that cause a party to be reminded of when a user executes a processing of content.

### BACKGROUND ART

In general, a user can moderately communicate with a specific party by operating a mobile terminal such as a mobile phone or PDA (Personal Digital Assistant) to transmit/receive an e-mail to/from the particular party. In the following description, a term “life log” is used for the date and time of operation, the location, log information indicating the location and the date and time of the operation, and the data used in the operation, when a user executes the operation such as transmission of e-mail, reception of e-mail, photography of an object, browsing of e-mail or websites and setup of music data for a ringtone in a daily life using the mobile terminal described above. For example, in a case where a user transmits an e-mail with an attached file to a friend by the mobile terminal, the life log includes the e-mail address of the friend, the transmission date and time of the e-mail, the location at the time of transmission, log information indicating that the e-mail is transmitted at the location on the date and time, the attached file and the substance of the e-mail text. As another example, in a case where a user has photographed a friend by a mobile terminal having a camera function, the life log includes the photography image of the friend as the object, the photography date and time, the location, log information indicating that the image is taken at the location on the date and time. As yet another example, in a case where a user has transmitted a post sentence to a web service such as an SNS (Social Network Service) by a mobile phone, the life log includes account information used at the time of transmission, and log information indicating a post substance or the like.

The life log is often stored in a storage unit such as a flash memory provided in the mobile terminal. In the course of technological development in recent years, a lot of technology to more facilitate communication between users has been proposed by actively using and analyzing the stored life log. For example, Patent Document 1 discloses a technology to promote communication between such as the users.

Patent Document 1 discloses a communication system and a communication method using an operation history. The communication system includes a plurality of communication terminals sharing the operation history of users, a management server that manages the communication terminals, and a communication terminal information database that registers the pieces of information related to the communication terminals. In a case where a command corresponding to the operation history is transmitted, the communication terminal information database is referenced in the management server, and the music and an abstracted image corresponding to the command are played and displayed in the destination communication terminal having the shared operation history.

According to the communication system and the communication method using the operation history as disclosed in Patent Document 1, the operation history is delivered among the plurality of people in the relationship with which the operation history of the communication terminal is allowed to be shared, whereby it is possible to increase the chance of thinking of the party without developing into a specific communication behavior such as a telephone or an e-mail.

### RELATED ART DOCUMENTS

### Patent Documents

Patent Document 1: JP-A-2005-333538

### SUMMARY OF THE INVENTION

### Problem to be Solved by the Invention

However, in Patent Document 1, it is necessary to designate in advance a party desired to be reminded by a user, as a communication terminal of which the operation history can be shared. That is, in Patent Document 1, since it is necessary to specify in advance the party desired to be reminded by the user as the communication terminal of which the operation history can be shared, it is necessary to proactively remember the party often, and it is difficult to specify a party as the party to share the operation history, for example, in a case where the party is forgotten by considerable date having been passed.

The present invention is made in view of the above-described circumstances, and an object thereof is to provide a content processing execution device, a content processing execution method, and programme, which can facilitate communication by reminding the user of the party to whom a processing of content is executed, by retaining the operation history information with respect to the party, and presenting the life log corresponding to the operation history information during the processing execution of the content such that a user can confirm it

### Means for Solving the Problem

The present invention provides a content processing execution device including: an operation history information storage unit that stores operation history information associated with an operation date and time of a content, an operation substance of the content and an operation party of the content; a life log storage unit that stores a life log corresponding to the operation substance of the operation history information of the content; a content processing execution control unit that acquires operation history information corresponding to the content from the operation history information storage unit in accordance with an instruction of a processing execution of input content; a life log acquisition unit that acquires the life log corresponding to the operation substance of the operation history information from the life log storage unit based on the operation history information that is acquired by the content processing execution control unit; and a life log presentation control unit that performs control so as to present the life log acquired by the life log acquisition unit when the processing of the content is executed.

Further, the present invention provides a content processing execution method including: a step of inputting an instruction of a processing execution of content; a step of acquiring operation history information of the content corresponding to the instruction from an operation history information storage unit that stores operation history information associated with an operation date and time of the content, an operation substance of the content, and an operation party of the content in accordance with the instruction of processing execution of the input content; a step of acquiring a life log corresponding to the operation substance of the operation history information from a life log storage unit that stores a life log corresponding to an operation substance of operation history information of the content based on the acquired operation history information; and a step of performing control so as to present the acquired life log when the processing of the content is executed.

Further, the present invention provides a programme which causes a content processing execution device which is a computer to execute: a step of inputting an instruction of a processing execution of content; a step of acquiring operation history information of the content corresponding to the instruction from an operation history information storage unit that stores operation history information associated with an operation date and time of the content, an operation substance of the content, and an operation party of the content in accordance with the instruction of processing execution of the input content; a step of acquiring a life log corresponding to the operation substance of the operation history information from a life log storage unit that stores a life log corresponding to an operation substance of operation history information of the content based on the acquired operation history information; and a step of performing control so as to present the acquired life log when the processing of the content is executed.

According to the configuration described above, it is possible to facilitate communication by reminding the user of the party to whom a processing of content is executed, by retaining the operation history information with respect to the party, and presenting the life log corresponding to the operation history information during the processing execution of the content such that a user can confirm it.

### Advantages of the Invention

According to a communication processing execution, a communication processing execution method, and a programme of the present invention, it is possible to facilitate communication by reminding a user of a party to whom a processing of content is executed, by retaining history information with respect to the party, and presenting a life log corresponding to the operation history information during the processing execution of the content such that a user can confirm it.

### BRIEF DESCRIPTION OF THE DRAWINGS

FIG. 1 is a block diagram showing an internal configuration of a mobile phone of the first embodiment.

FIG. 2 is an explanatory diagram showing the content of operation history information.

FIG. 3 is an explanatory diagram showing content of a life log management table.

FIG. 4 is an explanatory diagram showing a brief summary of operation of a mobile phone of the first embodiment, in which FIG. 4(a) is an explanatory diagram showing a state of selecting the content of music, and FIG. 4(b) is an explanatory diagram showing exemplary caption and life log that are displayed.

FIG. 5 is a flowchart describing the operation of a mobile phone of the first embodiment.

FIG. 6 is a block diagram showing the internal configuration of a mobile phone of the second embodiment.

FIG. 7 is an explanatory diagram showing the content of a caption template management table.

FIG. 8 is an explanatory diagram showing the brief summary of operation of a mobile phone of the second embodiment, in which FIG. 8(a) is an explanatory diagram showing a state of selecting the content of a music, FIG. 8(b) is an explanatory diagram showing an exemplary caption which is displayed, and FIG. 8(c) is an explanatory diagram showing an exemplary life log which is displayed.

FIG. 9 is a flowchart describing an operation of a mobile phone of the second embodiment.

FIG. 10 is a block diagram showing the internal configuration of a mobile phone of the third embodiment.

FIG. 11 is an explanatory diagram showing the brief summary of operation of a mobile phone of the third embodiment.

FIG. 12 is a flowchart describing the operation of a mobile phone of the third embodiment.

FIG. 13 is a block diagram showing the internal configuration of a mobile phone of the fourth embodiment.

FIG. 14 is an explanatory diagram showing the brief summary of operation of a mobile phone of the fourth embodiment, in which FIG. 14(a) is an explanatory diagram showing an exemplary caption which is displayed, FIG. 14(b) is an explanatory diagram showing exemplary life log which is displayed, FIG. 14(c) is an explanatory diagram showing an exemplary contact screen, and FIG. 14(d) is an explanatory diagram showing another exemplary contact screen.

FIG. 15 is an explanatory diagram showing the brief summary of operation of a mobile phone, in which FIG. 15(a) is an explanatory diagram showing an exemplary caption which is displayed, FIG. 15(b) is an explanatory diagram showing an exemplary life log which is displayed, FIG. 15(c) is an explanatory diagram showing an exemplary contact screen, and FIG. 15(d) is an explanatory diagram showing another exemplary contact screen.

FIG. 16 is a flowchart describing the operation of a mobile phone of the fourth embodiment.

FIG. 17 is an explanatory diagram showing an exemplary screen on which various types of button are displayed on a display unit of the conventional mobile phone.

### MODE FOR CARRYING OUT THE INVENTION

Hereinafter, the embodiment of the present invention will be described by referring to the drawings. In the embodiment of the following, as an exemplary content processing execution device of the present invention, the mobile phone, for an example, will be described. However, the content processing execution device of the present invention is not limited to a mobile phone. In addition, the present invention can be expressed as a device such as a mobile phone, or a “programme” to cause a computer, which is the device to be operated, furthermore, to be represented as a “method” including a step that is executed by a mobile phone 10. That is, the present invention can be represented as any category out of a device, a method and a programme. Further, in the following description, the processing execution of the content means an operation in which processing is executed to utilize the content, for example, in a case where the content is still image data, the substance of the processing execution means a “display” operation, and in a case where the content is video data or music data, the substance of the processing execution means a “play” operation.

### First Embodiment

### 1. Configuration of Mobile Phone 10 of the First Embodiment

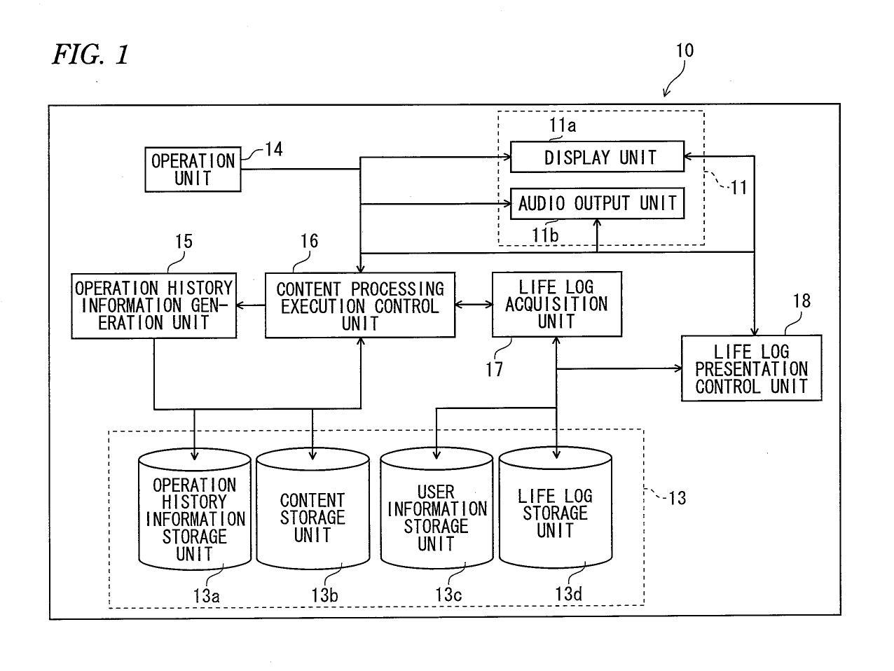

FIG. 1 is a block diagram showing an internal configuration of a mobile phone 10 of the first embodiment. As shown in FIG. 1, the mobile phone 10 includes a presentation unit 11, a storage unit 13, an operation unit 14, an operation history information generation unit 15, a content processing execution control unit 16, a life log acquisition unit 17, and a life log presentation control unit 18. Each unit of the mobile phone 10 will be described.

The presentation unit 11 is a unit that visually or aurally presents content and a life log to a user of the mobile phone 10, and is mainly configured by a display unit 11a, and an audio output unit 11b. The display unit 11a is configured of a display such as an LCD (Liquid Crystal Display) of the mobile phone 10, in response to the instruction of a processing execution of the content that is input by the operation unit 14, the display unit 11a displays the content, or the content and life log. Further, the audio output unit 11b is composed of a D/A (Digital/Analog) converter, an amplifier, a speaker and the like, in response to the instruction of the processing execution of the content that is input by the operation unit 14, the audio output unit 11b outputs a sound of the content, or the content and life log.

The storage unit 13 is composed of a memory media such as a ROM, a RAM, a hard disk, or a flash memory that is built in the mobile phone 10, and the storage unit 13 includes an operation history information storage unit 13a, a content storage unit 13b, a user information storage unit 13c, and a life log storage unit 13d. Each unit of the storage unit 13 will be described.

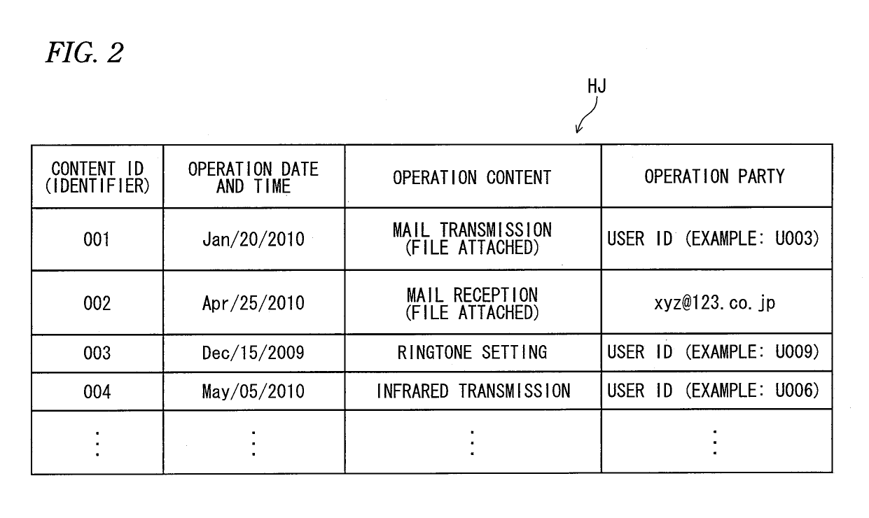

The operation history information storage unit 13a will be described with reference to FIG. 2. FIG. 2 is an explanatory diagram showing a content of operation history information HJ that is stored in the operation history information storage unit 13a. As shown in FIG. 2, in the operation history information storage unit 13a, with respect to a content ID that is an identifier of the content, the operation history information HJ that is associated with each of an operation date and time, an operation substance of the operation, and an operation party of the content is stored in table format.

For example, in the operation history information HJ of which the content ID is “001”, the operation date and time “20 Jan. 2010”, the operation substance “e-mail is transmitted in the state that there is an attached file”, and the operation party “user ID (=U003)” who is a target of the e-mail transmission are associated with each other. In addition, the user ID “U003” is a user identifier in the user information storage unit 13c, which will be described later. The user ID “U003” is the same as the following.

Further, for example, in the operation history information HJ of which the content ID is “002”, the operation date and time “25 Apr. 2010”, the operation substance “e-mail is received in the state that there is an attached file”, and the operation party “e-mail address (=xyz@ 123.co.jp)” who is the e-mail reception party are associated with each other. In addition, as a case where the information on the operation party is not a user ID but an e-mail address, for example, a case is applicable where the user information corresponding to the e-mail address is not stored in the user information storage unit 13c to be described later.

Further, for example, in the operation history information HJ of which the content ID is “003”, the operation date and time “15 Dec. 2009”, the operation substance “ringtone is set”, and the operation party “user ID (=U009)” who is the setting target of the ringtone are associated with each other. In addition, the user ID “U009” is a user identifier in the user information storage unit 13c, which will be described later. The user ID “U009” is the same as the following.

Further, for example, in the operation history information HJ of which the content ID is “004”, the operation date and time “5 May 2010”, the operation substance “infrared communication is performed”, and the operation party “user ID (=U006)” who is a target of the infrared transmission are associated with each other. In addition, the user ID “U003” is a user identifier in the user information storage unit 13c, which will be described later. The user ID “U006” is the same as the following.

In the content storage unit 13b, a content that is the instruction subject of a processing execution is stored, which is output by the operation unit 14. In the user information storage unit 13c, user information of the operation party of the operation history information HJ is stored. The user information, for example, is configured of a phone book data in which, for example, a name, an e-mail address, a telephone number, an address, a face photo in a thumbnail format, and account information of a web service of an operation party are all associated.

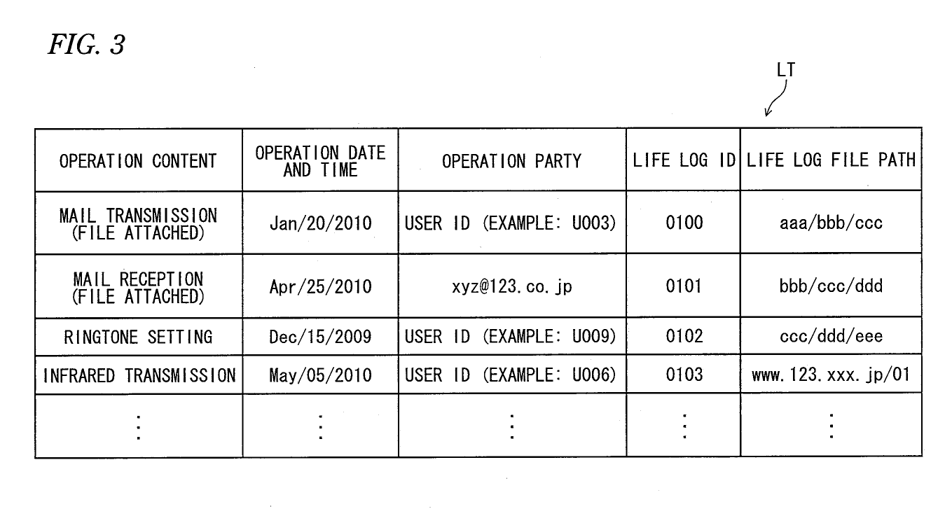

The life log storage unit 13d will be described with reference to FIG. 3. FIG. 3 is an explanatory diagram showing the content of life log management information LT that is stored in the life log storage unit 13d. As shown in FIG. 3, in the life log storage unit 13d, with respect to the operation substance of a content, the life log management information LT that is associated with the operation date and time of the content, the operation party of the content, a life log ID that is an identifier of the life log according to execution of the operation substance of the content, and a life log file path that is the memory location of the life log are stored in table format. Further, in the life log storage unit 13d, the life log corresponding to the life log ID is stored in the memory location shown by the life log file path.

For example, in life log management information LT of the operation substance of the content “e-mail is transmitted in the state that there is an attached file”, the operation date and time “20 Jan. 2010”, the operation party “user ID (=U003)” who is a target of the e-mail transmission, a life log ID “0100” of the life log saying that the e-mail is transmitted to the operation party on the operation date and time in the state that there is an attached file”, and the life log file path “aaa/bbb/ccc” of the life log are associated with each other.

Further, for example, in the life log management information LT of the operation substance of the content “e-mail is received in the state that there is an attached file”, the operation date and time “05 Apr. 2010”, the operation party “e-mail address (=xyz @ 123.co.jp)” who is the e-mail reception party, a life log ID “0101” of the life log saying that the e-mail is received to the operation party on the operation date and time in the state that there is an attached file, and the life log file path “bbb/ccc/ddd” of the life log are associated with each other.

Further, for example, in the life log management information LT of the operation substance of the content “ringtone is set”, the operation date and time “15 Dec. 2009”, the operation party “user ID (=U009)” who is a setting subject of the ringtone, a life log ID “0102” of the life log saying that the ringtone is set to the operation subject person on the operation date and time, and the life log file path “ccc/ddd/eee” of the life log are associated with each other.

Further, for example, in the life log management information LT of the operation substance of the content “infrared communication is performed”, the operation date and time “5 May 2010”, the operation party “user ID (=U006)” who is a communication target of the infrared communication, a life log ID “0103” of the life log saying that the infrared communication is performed to the operation subject person on the operation date and time, and the life log file path “www.123.xxx.jp/01” of the life log are associated with each other.

Further, the storage unit 13 stores each programme in which the operations of the operation unit 14, the operation history information generation unit 15, the content processing execution control unit 16, the life log acquisition unit 17 and the life log presentation control unit 18 are prescribed in advance. Further, in the operation of the operation unit 14, the operation history information generation unit 15, the content processing execution control unit 16, the life log acquisition unit 17 and the life log presentation control unit 18, the storage unit 13 also operates as the respective work memory.

In addition, the operation unit 14, the operation history information generation unit 15, the content processing execution control unit 16, the life log acquisition unit 17 and the life log presentation control unit 18 can be configured by hardware or software. In particular, when these units are configured by software, a programme in which operation of these units is prescribed in advance is loaded by a CPU that is built in the mobile phone 10, where the units include the operation unit 14, the operation history information generation unit 15, the content processing execution control unit 16, the life log acquisition unit 17 and the life log presentation control unit 18, accordingly, each unit of the operation unit 14, the operation history information generation unit 15, the content processing execution control unit 16, the life log acquisition unit 17 and the life log presentation control unit 18 can be operated.

The operation unit 14 is configured of software having various types of function buttons that are functionally assigned corresponding to each usable application in the mobile phone 10, a direction key, a numeric keypad, or hardware such as a touch panel which is disposed on the display unit 11a, or a software keyboard having functions such as the function button, the keypad, or the direction key to the display unit 11a, each of which is virtually displayed. The operation unit 14 detects an instruction for processing execution of the content that is input by the user for hardware or software described above, and outputs an operation signal corresponding to the instruction of the processing execution of the content which is detected to the content processing execution control unit 16. In the operation signal, a content ID, which is an identifier of the content, is included.

The operation history information generation unit 15 is configured by such as a CPU, a DSP, a ROM and a RAM which are built in the mobile phone 10, and a content corresponds to the content ID included in the operation signal that is output by the operation unit 14, in this case, when the processing of the content is executed by the content processing execution control unit 16, the information that the processing execution is completed is acquired by the content processing execution control unit 16. The operation history information generation unit 15, based on the information that is acquired by the content processing execution control unit 16, generates the operation history information HJ of the content, and stores the generated history information HJ in the operation history information storage unit 13a.

The content processing execution control unit 16 is configured by such as a CPU, a DSP, a ROM, and a RAM which are built in the mobile phone 10, and acquires the operation signal that is output by the operation unit 14. The content processing execution control unit 16 acquires the content ID included in the acquired operation signal, and searches the content storage unit 13b based on the acquired content ID. In case where content corresponds to the content ID of the search result, the content processing execution control unit 16 performs control so as to present the content that is acquired to the presentation unit 11 by acquiring a content corresponding to the content ID from the content storage unit 13b. That is, the content processing execution control unit 16 controls to cause the content that is acquired from the content storage unit 13b to be displayed on the display unit 11a, or controls to cause the acquired content to be output as a sound to the audio output unit 11b.

Further, the content processing execution control unit 16 searches the operation history information storage unit 13a based on the acquired content ID, and acquires the operation history information HJ corresponding to the content ID. In addition, in the first and second embodiments, the acquired operation history information HJ is a single item. As will be described later, in the third and fourth embodiments, a plurality of operation history information HJ items is acquired. The content processing execution control unit 16 outputs the operation substance of the acquired single operation history information HJ and each piece of information of the operation party to the life log acquisition unit 17.

The life log acquisition unit 17 is configured by such as a CPU, a DSP, a ROM, and a RAM, and acquires the operation substance of the operation history information which is output by the content processing execution control unit 16 and each piece of information on the operation party. The life log acquisition unit 17 searches the user information storage unit 13c based on acquired information of the operation party, and acquires the user information of the operation party. The life log acquisition unit 17 outputs the acquired user information to the life log presentation control unit 18.

In addition, in a case where the user information of the operation party is not stored in the user information storage unit 13c, the life log acquisition unit 17 takes dummy data that is stored in advance in the user information storage unit 13c as user information, and outputs the dummy data to the life log presentation control unit 18. The dummy data, for example, as an indication that the user information is not stored in the user information storage unit 13c, for example, includes such as text information of a pattern mark, or pattern mark images. Further, in a case where the user information of the operation party is not stored in the user information storage unit 13c, the life log acquisition unit 17 may also output information suggesting the operation party directly included in the life log that is stored in the life log storage unit 13d to the life log presentation control unit 18 as the user information. Here, the information suggesting the operation party that is directly included in the life log, for example, in a case where the life log is e-mail, includes the transmission party of the e-mail or the e-mail address of reception party.

Further, the life log acquisition unit 17 searches the life log storage unit 13d based on information of the acquired operation substance, and acquires an operation date and time and a life log file path of the life log management information LT that include information of the operation substance, and a life log that is stored in a memory location shown by the life log file path. In addition, the life log file path may also be a path showing the internal memory location of the life log storage unit 13d, or a URL (Uniform Resource Locator) showing the memory location on an external server device of “www.123.xxx. co.jp/01” shown in FIG. 3. Further, the life log file path may also be a URL showing a reference for the web service. In this case, account information of the web service is acquired from the user information storage unit 13c, and the life log corresponding to the account information of the web service is acquired from the memory location corresponding to the URL. The life log acquisition unit 17 outputs the acquired information of the operation date and time, and a life log corresponding to the operation substance to the life log presentation control unit 18.

Further, the life log acquisition unit 17 searches the life log storage unit 13d based on acquired information of the operation party, and may also acquire an operation date and time of the life log management information LT that includes information of the operation party, and a life log that is stored in a memory location shown by the life log file path. The life log acquisition unit 17 outputs the acquired information of the operation date and time, and a life log corresponding to the operation party to the life log presentation control unit 18. The same applies to the following embodiments.

The life log presentation control unit 18 is configured by such as a CPU, a DSP, a ROM and a RAM which are built in the mobile phone 10, and acquires information of the operation date and time, and a life log corresponding to user information and the operation substance that are output by the life log acquisition unit 17. While the content processing execution control unit 16 executes the processing of the acquired content from the content storage unit 13b, the life log presentation control unit 18 performs control so as to present the acquired information of the operation date and time, and the life log corresponding to the user information and the operation substance to the presentation unit 11.

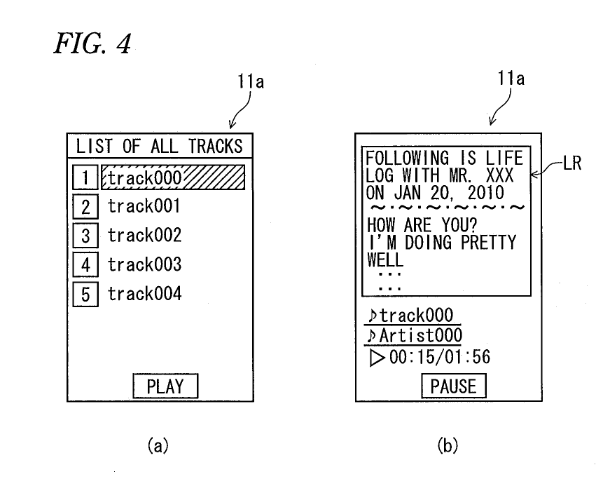

That is, the life log presentation control unit 18, meanwhile the content processing execution control unit 16 executes the processing of content that is acquired from the content storage unit 13b, performs control so as to cause information of the operation date and time, the life log corresponding to the user information and the operation substance that are acquired from the life log acquisition unit 17 to be displayed on the display unit 11a. Alternatively, the life log presentation control unit 18, meanwhile the content processing execution control unit 16 executes the processing of content that is acquired from the content storage unit 13b, performs control so as to cause the information of the operation date and time, the life log corresponding to the user information, and the operation substance that are acquired from the life log acquisition unit 17 to be output to the audio output unit 11b as a sound. In addition, when the information of the operation date and time, the life log corresponding to the user information, and the operation substance are displayed on the display unit 11a, it may be preferable that a display area of the display unit 11a (refer to FIG. 4(b)) be prescribed in advance in the operation of the life log presentation control unit 18. For example, as shown in FIG. 4(b) to be described later, the life log presentation control unit 18 displays the information of the operation date and time, the life log corresponding to the user information, and the operation substance that are acquired from the life log acquisition unit 17 on the display area LR.

Further, the life log presentation control unit 18 may also acquire the life log corresponding to the information of the operation date and time, the user information, and the operation substance that are output by the life log acquisition unit 17 or the life log corresponding to the operation party. In this case, the life log presentation control unit 18, meanwhile the content processing execution control unit 16 executes the processing of content that is acquired from the content storage unit 13b, performs control so as to present the information of the operation date and time, the life log corresponding to the user information, and the operation substance that are acquired to the presentation unit 11, and after that, the life log presentation control unit 18 performs control so as to present the information of the operation date and time, the life log corresponding to the user information, and the operation substance that are acquired to the presentation unit 11. In this manner, because both the life log corresponding to the operation substance and the life log corresponding to the operation party are presented to the user, rather than presenting only the life log corresponding to the operation substance to the presentation unit 11, the mobile phone 10 can remind the user of the operation party with high probability.

That is, the life log presentation control unit 18, meanwhile the content processing execution control unit 16 executes the processing of content that is acquired from the content storage unit 13b, displays the information of the operation date and time, the life log corresponding to the user information, and the operation substance that are acquired from the life log acquisition unit 17 to be displayed on the display unit 11a for a predetermined period of time. Continuing after that, the life log presentation control unit 18 performs control so as to cause information of the operation date and time, the life log corresponding to the user information, and the operation party that are acquired to be displayed on the display unit 11a for the same predetermined period of time. In addition, in a case where the life log corresponding to the operation substance or the life log corresponding to the operation party is a plural number, the life log presentation control unit 18 causes the life log presentation control unit 18 to be displayed in order on the display unit 11a for a predetermined period of time as described above. The same applies to the following embodiments.

Alternatively, the life log presentation control unit 18, meanwhile the content processing execution control unit 16 executes the processing of content that is acquired from the content storage unit 13b, performs control so as to cause the life log corresponding to information of the operation date and time, the user information, and the operation substance that are acquired from the life log acquisition unit 17 to be output to the audio output unit 11b as a sound. Alternatively, by using an existing silence interval detection mechanism, it may cause the sound to be output during a silence interval. Continuing after that, the life log presentation control unit 18 performs control so as to cause the information of the operation date and time, the life log corresponding to the user information, and the operation party that are acquired from the life log acquisition unit 17 to be output to the audio output unit 11b as a sound for a predetermined period of time. In addition, in a case where there are plural number of the life log corresponding to the operation substance or the life log corresponding to the operation party is a plural number, the life log presentation control unit 18 cause the life log presentation control unit 18 to be output in order to the audio output unit 11b as a sound for a predetermined period of time as described above. The same applies to the following embodiments.

Further, the predetermined time in which the above described life log is displayed on the display unit 11a or the predetermined time that is output as a sound to the audio output unit 11b may be prescribed in advance in the operation of the life log presentation control unit 18. In particular, in a case where the content is music data or video data, the life log presentation control unit 18 acquires information of the play time of a content from the content processing execution control unit 16, during a short time interval (for example 5 “seconds”) that corresponds to information of the play time, the life log is displayed on the display unit 11a, and is output as a sound to the audio output unit 11b. Alternatively, in a case where the content is the music data or the video data, the life log presentation control unit 18 acquires information of the play time of a content from the content processing execution control unit 16, during a time interval that corresponds to, for example, a tenth ( 1/10) of the information of the play, the life log is displayed on the display unit 11a, and is output as a sound to the audio output unit 11b. For example, in a case where the play time of the content is three minutes, the display time or audio output time of the single life log is 18 seconds that is a tenth ( 1/10) of the play time of the content. Furthermore, in a case where a plurality of life log is displayed or output as a sound, it may be preferable for the display or the audio output of each life log to be switched every 18 seconds by the life log presentation control unit 18. The same is applied to the following embodiments.

In addition, when the life log corresponding to information of the operation data and time, the user information, and the operation party is displayed on the display unit 11a, it may be preferable that a display area of the display unit 11a (refer to FIG. 4(b)) be prescribed in advance in the operation of the life log presentation control unit 18. In the same manner, when the life log corresponding to information of the operation data and time, the user information, and the operation substance is displayed on the display unit 11a, it may be preferable that a display area of the display unit 11a (refer to FIG. 4(b)) be prescribed in advance in the operation of the life log presentation control unit 18. For example, as shown in FIG. 4b to be described later, the life log presentation control unit 18 displays the life log corresponding to the information of the operation date and time, the user information, and the operation substance on the life log display area LR. The same is applied to the following embodiments.

Further, when a life log presentation control unit 18 presents a life log corresponding to user information and the operation substance or a life log corresponding to information of the operation date and time, the operation party to the presentation unit 11, it may be preferable to present a simple description of the life log that includes information of the operation date and time or user information, or information of the operation date and time and user information. For example, as shown in FIG. 4(b) to be described later, the life log presentation control unit 18 displays a text of the life log described as “Following is the life log of Mr. XXX on 20 Jan. 2010” on the life log display area LR. In this manner, because a simple description of the life log is presented, it is possible for the user to be reminded of the substance of the life log with high probability. In the following description, a description substance of a life log using information of the operation date and time or user information, or information of the operation date and time and user information is referred to as “caption”. In the first embodiment, template data of the caption, which is in the state of lacking in information of the operation date and time, and user information from the caption, is the data that is prescribed in advance in the operation of the life log presentation control unit 18.

### 2. Description for Operation of Mobile Phone 10 of the First Embodiment

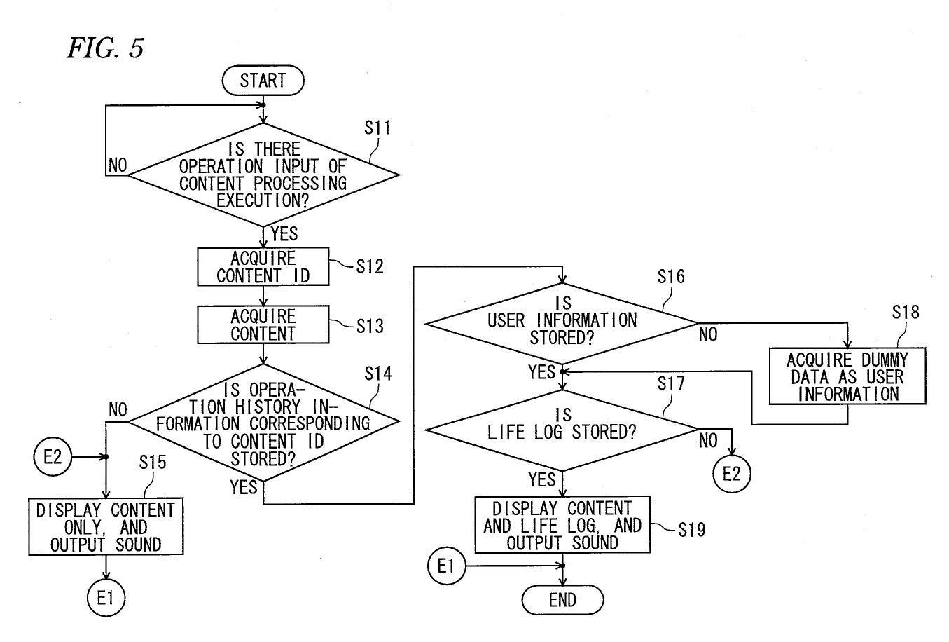

The operation of the mobile phone 10 of the first embodiment will be described by referring to FIGS. 4 and 5. FIG. 4 is an explanatory diagram showing a brief summary of operation of the mobile phone 10 of the first embodiment. FIG. 4(a) is an explanatory diagram showing a state of selecting the content when content is music data. Further, FIG. 4(b) is an explanatory diagram showing an exemplary caption and life log that are displayed on the display unit 11a during play of the content. FIG. 5 is a flowchart describing the operation of the mobile phone 10 that is content processing execution device of the first embodiment. Hereinafter, in the FIGS. 4 and 5, the operation history information HJ of which the content is music data, acquired by the content processing execution control unit 16 is described as being the operation history information HJ with respect to the content ID “001” shown in FIG. 2.

In FIG. 5, the content processing execution control unit 16, as shown in FIG. 4(a), selects any one of content item out of five items of music data “track 000”, “track 001”, “track 002”, “track 003”, and “track 004” that a user caused to display on the display unit 11a by operating the operation unit 14 and determines whether or not the operation that a play button is pressed down is performed (S11). In addition, as described above, in a case where the operation is performed, the operation unit 14 outputs the operation signal to the effect that operation including the content ID of the content is performed to a content processing execution control unit 16. Further, the contents “track 000”, “track 001”, “track 002”, “track 003”, and “track 004” are considered to be respectively content ID “001”, “002”, “003”, “004” and “005”.

In the step S11, when the operation is determined to be performed (S11, YES), the content processing execution control unit 16 acquires the content ID of a content that is operated from the operation signal that is output by the operation unit 14 (S12). The content processing execution control unit 16 searches the content storage unit 13b based on the content ID that is acquired by the step S12 and acquires a content corresponding to the content ID (S13).

Further, the content processing execution control unit 16 searches the operation history information storage unit 13a based on the content ID that is acquired by step S12, and determines whether or not the operation history information HJ corresponding to the content ID is stored in the operation history information storage unit 13a (S14).

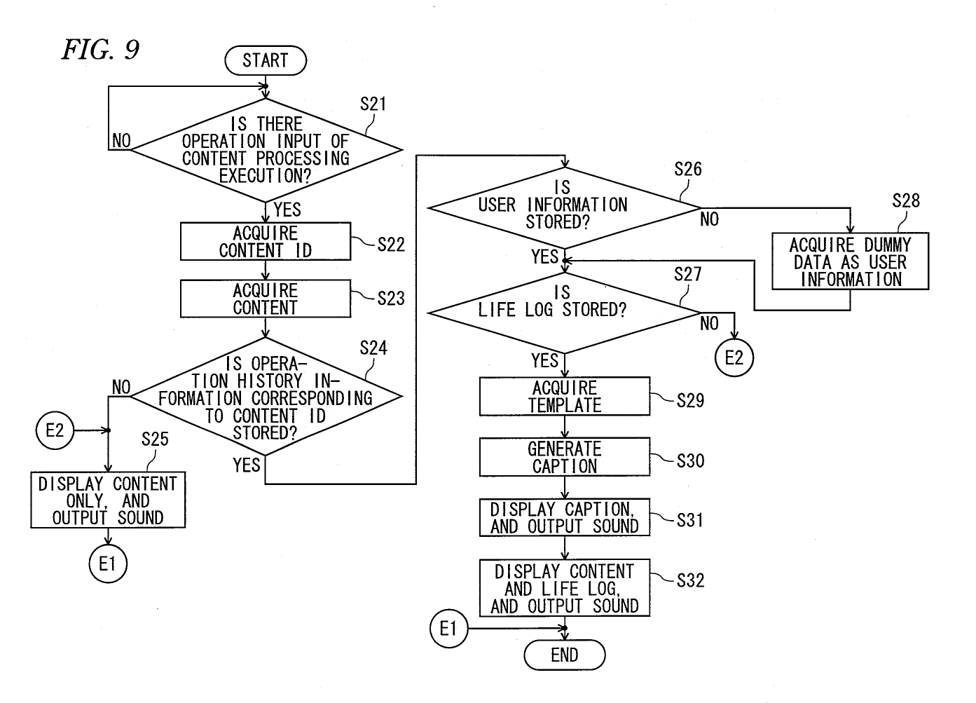

In the step S14, in a case where the operation history information HJ is determined not to be stored in the operation history information storage unit 13a (S14, NO), the content processing execution control unit 16 performs control so as to present the content that is acquired by the step S13 to the presentation unit 11 (S15), and then the flowchart of FIG. 5 is completed. That is, in the step S15, the content processing execution control unit 16, in a case where the content that is acquired by the step S13 is music data, performs control so as to play back the content that is the music data and cause the music data to be output as a sound to the audio output unit 11b by playing the content. In addition, in the description of FIG. 9, although it is assumed that the content is the music data, in the step S15, the content processing execution control unit 16, in a case where the content that is acquired by the step S13 is still image data, performs control so as to display the content that is the still image data on the display unit 11a.

In the step S14, in a case where the operation history information HJ is determined to be stored in the operation history information storage unit 13a (S14, YES), the content processing execution control unit 16 outputs an operation substance of the acquired operation history information HJ and each piece of information of the operation party to the life log acquisition unit 17. The life log acquisition unit 17 searches the user information storage unit 13 based on the information of the operation party that is output by the content processing execution control unit 16, and determines whether or not the user information of the operation party is stored in the user information storage unit 13c (S16).

In the step S16, in a case where the user information of the operation party is determined to be stored in the user information storage unit 13c (S16, YES), the life log acquisition 17 acquires the user information from the user information storage unit 13c, outputs the acquired user information to the life log presentation control unit 18, and proceeds to the operation of step S17.

In the step S16, the user information of the operation party is determined not to be stored in the user information storage unit 13c (S16, NO), the life log acquisition 17 acquires a dummy data that is stored in advance in the user information storage unit 13c as user information (S18), outputs the dummy data to the life log presentation control unit 18, and proceeds to the operation of step S17.

In the step S17, the life log acquisition unit 17 searches the life log storage unit 13d based on the information of the operation substance that is output by the content processing execution control unit 16, and determines whether or not life log management information LT including information of the operation substance is stored in a life log storage unit 13d (S17).

In the step S17, in a case where the life log management information LT is determined to be stored in the life log storage unit 13d (S17, YES), the life log acquisition unit 17 acquires a life log that is stored in a memory location shown by an operation date and time and a life log file path of the life log management information LT that include information of the operation substance, and the life log file path. In addition, the life log acquisition unit 17 outputs the acquired operation date and time and the life log to the life log presentation control unit 18. Thereafter, the process proceeds to the operation of step S19.

In the step S17, in a case where the life log management information LT is determined not to be stored in the life log storage unit 13d (S17, NO), because presentation of the life log is finally not performed for a user, the life log acquisition unit 17 outputs information to the effect that the life log is not stored in the life log storage unit 13d to the content processing execution control unit 16. The content processing execution control unit 16, based on the information that is acquired by the life log acquisition unit 17, as the same as the operation of the step S16, in response to the content that is acquired by the step S13, performs control so as to present the content to the presentation unit 11, and then the flowchart of FIG. 5 is completed.

In step S19, the life log presentation control unit 18 acquires information of the operation date and time, user information and a life log that are output by the life log acquisition unit 17. The life log presentation control unit 18, meanwhile the content processing execution control unit 16 executes the processing of content that is acquired from the content storage unit 13b, performs control so as to present the acquired information of the operation date and time, the user information, and the life log to the presentation unit 11 (S19). In particular, in a case where the content is music data or video data, the life log presentation control unit 18 acquires information of the play time of a content from the content processing execution control unit 16, for example, it is preferable for the content to control so as to present the life log to the presentation unit 11 after a predetermined time elapsed from the start of the play of the content. It is preferable for the predetermined time from the play of the content to the presentation of the life log to be prescribed in advance in an operation of the life log presentation control unit 18.

For example, the life log presentation control unit 18, as shown in FIG. 4(b), meanwhile the content processing execution control unit 16 executes (plays) the processing of content “track 000” that is acquired from the content storage unit 13b, performs control so as to cause information of the operation date and time, the user information, and the life log that are acquired from the life log acquisition unit 17 to be displayed on the display unit 11a. In the life log display area LR of the display unit 11a shown in FIG. 4(b), based on the operation history information HJ of “track 000” that is a selected content ID “001” in FIG. 4(a), information of the operation date and time, user information, a simple caption, and life log as well are displayed.

More specifically, the life log presentation control unit 18, based on information of the operation date and time and user information (Mr. XXX) that are acquired from the life log acquisition unit 17, displays a life log caption “Following is the life log of Mr. XXX on 20 Jan. 2010”, the life log that is an e-mail text message that is transmitted to the operation party (Mr. XXX) “How are you? I'm doing pretty well . . . ” on the life log display area LR of the display unit 11a. Further, as described above, in a case where user information of Mr. XXX who is the operation party is not stored in the user information storage unit 13c, it may also be allowed for the life log acquisition unit 17 to output an e-mail address of transmission party of the e-mail that is directly included in the life log from the life log storage unit 13d as user information that is acquired from the life log acquisition unit 17 to the life log presentation control unit 18. In this case, the life log presentation control unit 18 displays a life log caption “Following is the life log of Mr. “e-mail address:xyz@123.co.jp” on 20 Jan. 2010” on the life log display area LR of the display unit 11a.

As above, the mobile phone 10 of the first embodiment retains the operation history information HJ with the operation party to whom the processing of the content is executed, and while executing the processing of the content, the presentation of the life log corresponding to the operation history information HJ, or the life log caption and the life log is confirmed to a user, in such a manner that it is possible to promote the communication by reminding the user of the party.

Further, even when the user information of the operation party is not stored, the mobile phone 10 treats dummy data that is stored in advance in the user information storage unit 13c as user information, and since the mobile phone 10 presents the life log by the presentation unit 11 (display unit 11a and audio output unit 11b), it is possible to cause the possibility of reminding the user of the party to be relatively improved, compared to a case where the life log itself is not presented. The effect of using such dummy data is the same in each of the following embodiments.

### Second Embodiment

### 3. Configuration of Mobile Phone 10s of the Second Embodiment

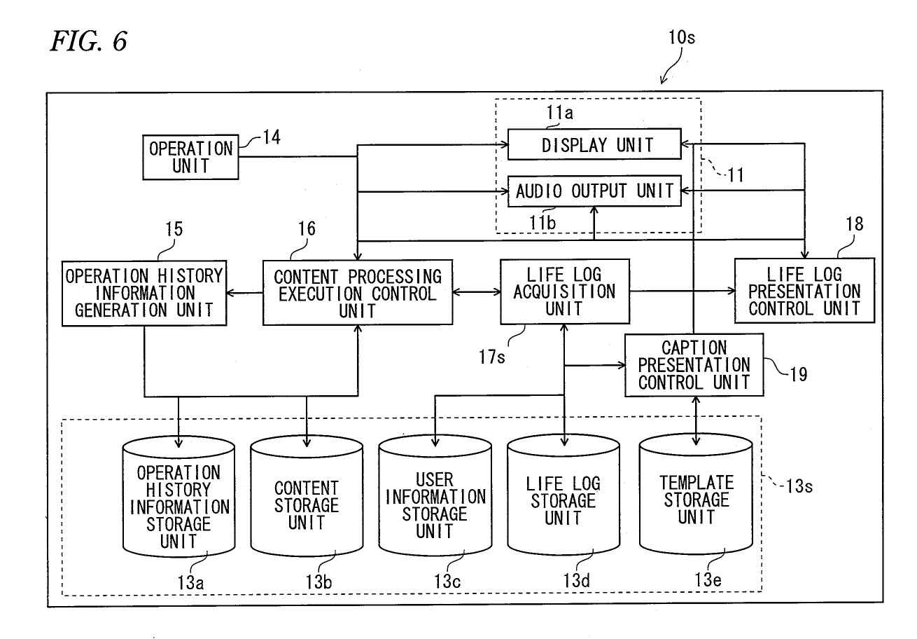

FIG. 6 is a block diagram showing the internal configuration of a mobile phone 10s of the second embodiment. As shown in FIG. 6, the mobile phone 10s includes a presentation unit 11, a storage unit 13, an operation unit 14, an operation history information generation unit 15, a content processing execution control unit 16, a life log acquisition unit 17s, a life log presentation control unit 18, and a caption presentation control unit 19. The mobile phone 10s of the second embodiment further includes the caption presentation control unit 19 in the mobile phone 10 of the first embodiment, and the same reference numerals are attached to common parts with FIG. 1, a detailed description thereof will be omitted and description will be mainly made of differing.

In the first embodiment, template data of the caption, which is in the state of lacking information of the operation date and time, and user information from the caption, has been prescribed in advance in the operation of the life log presentation control unit 18. In the second embodiment, the template data is determined in accordance with information of an operation substance of operation history information HJ, and is stored in a template storage unit 13e in plural number. The caption presentation control unit 19 performs control so as to acquire the template data from the template storage unit 13e, generate a caption based on the acquired template data, and present the generated caption to the presentation unit 11.

The storage unit 13s includes an operation history information storage unit 13a, a content storage unit 13b, a user information storage unit 13c, a life log storage unit 13d, and a template storage unit 13e. Since the operation history information storage unit 13a, the content storage unit 13b, the user information storage unit 13c, and the life log storage unit 13d are the same as what is included in the storage unit 13 of the first embodiment, a description that is related to the same units will be omitted, and the template storage unit 13e will be described.

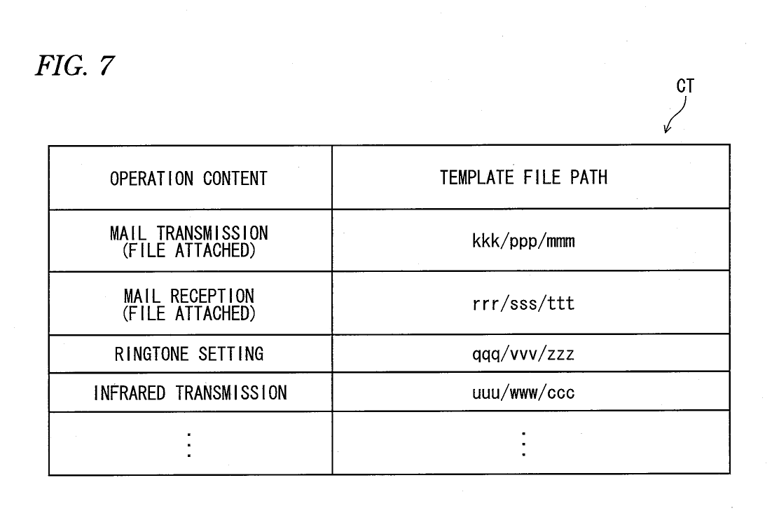

The template storage unit 13e will be described by referring to FIG. 7. FIG. 7 is an explanatory diagram describing the substance of template management information CT that is stored in the template storage unit 13e. As shown in FIG. 7, in the template storage unit 13e, the template management information CT with which a template file path that is a memory location of the template data of the caption is associated is stored in table format. Further, in the template storage unit 13e, the template data is stored in the memory location shown by the template file path of the template management information CT.

For example, in the template management information CT of an operation substance of content “to transmit an e-mail in the state of having an attached file”, the template file path “kkk/ppp/mmm” is associated.

Further, for example, in the template management information CT of an operation substance of the content as “to receive an e-mail in the state of having an attached file”, the template file path “rrr/sss/ttt” is associated.

Further, for example, in the template management information CT of an operation substance of the content as “to set a ringtone”, the template file path “qqq/vvv/zzz” is associated.

Further, for example, in the template management information CT of an operation substance of the content as “to perform an infrared communication”, the template file path “uuu/www/ccc” is associated.

Further, the storage unit 13s each stores each programme in which the operations of the operation unit 14, the operation history information generation unit 15, the content processing execution control unit 16, the life log acquisition unit 17s, the life log presentation control unit 18, and the caption presentation control unit 19 are prescribed in advance. Further, in the operations of the operation unit 14, the operation history information generation unit 15, the content processing execution control unit 16, the life log acquisition unit 17s, the life log presentation control unit 18, and the caption presentation control unit 19, the storage unit 13 also operates also as the respective work memory.

In addition, the operation unit 14, the operation history information generation unit 15, the content processing execution control unit 16, the life log acquisition unit 17s, the life log presentation control unit 18 and the caption presentation control unit 19 can be configured in hardware or software. In particular, when these units are configured by the software, a programme in which operations of the operation unit 14, the operation history information generation unit 15, the content processing execution control unit 16, the life log acquisition unit 17s, the life log presentation control unit 18 and the caption presentation control unit 19 are prescribed in advance is loaded by a CPU that is built in the mobile phone 10s, where the units include the operation unit 14, the operation history information generation unit 15, the content processing execution control unit 16, the life log acquisition unit 17s, the life log presentation control unit 18, and the caption presentation control unit 19, which can be operated respectively.

The life log acquisition unit 17s outputs each piece of information of an operation date and time, and an operation substance, and user information as well to the caption presentation control unit 19.

The caption presentation control unit 19 is configured by such as a CPU, a DSP, a ROM, and a RAM, and acquires the each piece of the operation date and time and the operation substance, and the user information as well that is output by the life log acquisition unit 17s. The caption presentation control unit 19 searches the template storage unit 13e based on the acquired information of the operation substance, and acquires a template file path corresponding to the operation substance. The caption presentation control unit 19 acquires the template data from the memory location shown by the t acquired template file path.

Further, the caption presentation control unit 19, when a processing of the content that the content processing execution control unit 16 acquires from the content storage unit 13b is started to execute, generates a caption to present to the presentation unit 11 based on the acquired each piece of information of the operation date and time and the operation substance, the template data of the caption, and the user information as well. The caption presentation control unit 19 performs control so as to present the generated caption to the presentation unit 11.

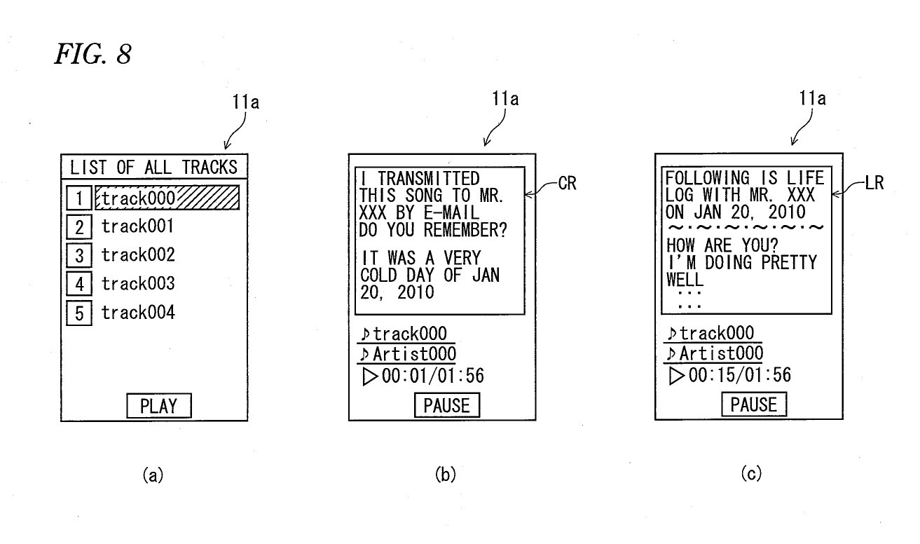

That is, the caption presentation control unit 19, when the processing of the content that the content processing execution control unit 16 acquires from the content storage unit 13b is started to execute, performs control so as to cause the substance of the generated caption to be displayed on the display unit 11a. Alternatively, the caption presentation control unit 19, when the processing of the content that the content processing execution control unit 16 acquires from the content storage unit 13b is started to execute, performs control so as to cause the substance of the generated caption to be output as a sound to an audio output unit 11b. In addition, when the content of the caption that includes each piece of information of an operation date and time, template data, and user information as well is displayed on the display unit 11a, it may be preferable that the display area of the display unit 11a (refer to FIG. 8(b)) be prescribed in advance in the operation of the caption presentation control unit 19. For example, as shown in FIG. 8(b), to be described later, the caption presentation control unit 19 displays the caption that includes each piece of information of the operation date and time and the operation substance, the template data, and user information as well on a caption display area CR.

### Description for Operation of Mobile Phone 10s of the Second Embodiment

The operation of the mobile phone 10s of the second embodiment will be described by referring to FIGS. 8 and 9. FIG. 8 is an explanatory diagram showing a brief summary of operation of the mobile phone 10s of the second embodiment. FIG. 8(a) is an explanatory diagram showing a state of selecting the content when content is music data. Further, FIG. 8(b) is an explanatory diagram showing an exemplary caption that is displayed on the display unit 11a at the start of play of the content. FIG. 8(c) is an explanatory diagram showing an exemplary life log that is displayed on the display unit 11a during the play of the content. FIG. 9 is a flowchart describing an operation of the mobile phone 10s of the second embodiment. Hereinafter, in FIGS. 8 and 9, the operation history information HJ of which the content is music data, acquired by the content processing execution control unit 16 is described as being the operation history information HJ with respect to the content ID “001” shown in FIG. 2.

In FIG. 9, the operation substance from a step S21 to a step S26 and a step S28 is overlapped with the operation substance from a step S11 to step S16 and a step S18 of the operation substance for the mobile phone 10 of the first embodiment shown in FIG. 5. Therefore, a description of the operation substance from the S21 to the step S26 and the step S28 is omitted. However, the operation substance from the step S21 to the step S26 and the step S28 can be described to a feasible extent by substituting it with the operation substance from the corresponding step S11 to the step S16 and the step S18 of first embodiment.

Further, the life log acquisition unit 17s searches the life log storage unit 13d based on the information of the operation substance that is output by the content processing execution control unit 16, and determines whether or not a life log management information LT including information of the operation substance is stored in the life log storage unit 13d (S27).

In the step S27, the life log management information LT is determined to be stored in the life log storage unit 13d (S27, YES), the life log acquisition unit 17s acquires a life log that is stored in a memory location shown by an operation date and time that include information of the operation substance, and a life log file path of the life log management information LT, and the life log file path. The life log acquisition unit 17s outputs the operation date and time and the life log that are acquired to the life log presentation control unit 18. Furthermore, the life log acquisition unit 17s outputs the information of the operation substance that is output by the content processing execution control unit 16 to the caption presentation control unit 19. Thereafter, the process proceeds to the operation of step S29.

In the step S27, in a case where the life log management information LT is determined not to be stored in the life log storage unit 13d (S27, NO), because a presentation of the life log is finally not performed for a user, the life log acquisition unit 17s outputs information to the effect that the life log is not stored in the life log storage unit 13d to the content processing execution control unit 16. The content processing execution control unit 16, based on the information that is acquired by the life log acquisition unit 17, as the same as the operation of the step S26, in response to the content that is acquired by the step S23, performs control so as to present the content to the presentation unit 11, and then the flowchart of FIG. 9 is completed.

In step S29, the caption presentation control unit 19 acquires each piece of information of an operation date and time and an operation substance, and user information as well that are output by the life log acquisition unit 17s. The caption presentation control unit 19 searches the template storage unit 13e based on the information of the acquired operation substance, and acquires a template file path corresponding to the operation substance. The caption presentation control unit 19 acquires the template data from the memory location shown by the acquired template file path (S29).

Further, the caption presentation control unit 19 generates a caption to present to the presentation unit 11 based on each piece of information of the operation date and time and the operation substance, the template data, and the user information as well that are acquired (S30). The caption presentation control unit 19 performs control so as to present the generated caption to the presentation unit 11 (S31). That is, the caption presentation control unit 19 performs control so as to cause the substance of the generated caption to be displayed on the display unit 11a. Alternatively, the caption presentation control unit 19 performs control so as to cause the substance of the generated caption to be output as a sound to an audio output unit 11b.

For example, the caption presentation control unit 19, as shown in FIG. 8(b), when the content processing execution control unit 16 start to execute the processing of (plays) content “track 000” that is acquired from the content storage unit 13b, performs control so as to cause the caption to be displayed on the display unit 11a, which is generated based on each piece of information of the operation date and time, the template data of the caption, and the user information as well that are acquired from the life log acquisition unit 17. In a caption display area CR of the display unit 11a shown in FIG. 8(b), based on the operation history information HJ of “track 000” that is a selected content ID “001” in FIG. 8(a), a caption that includes each piece of information of the operation date and time and the operation substance, the template data of the caption, and the user information as well is displayed.

More specifically, the caption presentation control unit 19, based on each piece of information of the operation date and time and operation substance, the template data of the caption, and the user information that are acquired from the life log acquisition unit 17s, displays a caption such as “You transmitted this song to Mr. XXX through E-E-mail. Do you remember? It was the very cold day of 20 Jan. 2010”, on the caption display area CR. In addition, the caption presentation control unit 19 may also acquire such as weather information or case information that is related to the operation date and time from the device such as an external server that is connected with the mobile phone 10s through a network, and may also generate the caption by including such as the weather information or the case information as the substance of the caption.

After the caption according to step S31 being presented by the presentation unit 11, the life log presentation control unit 18 acquires the information of the operation date and time, the user information and the life log that are output by the life log acquisition unit 17s. The life log presentation control unit 18, while the content processing execution control unit 16 executes the content processing of content that is acquired from the content storage unit 13b, performs control so as to present the acquired information of the operation date and time, the user information, and the life log to the presentation unit 11 (S32).

For example, the life log presentation control unit 18, as shown in FIG. 8(c), while the content processing execution control unit 16 executes the processing (plays) of content “track 000” that is acquired from the content storage unit 13b, performs control so as to cause information of the operation date and time, the user information, and the life log that are acquired from the life log acquisition unit 17s to be displayed on the display unit 11a. In the life log display area LR of the display unit 11a shown in FIG. 8(c), based on the operation history information HJ of “track 000” that is a selected content ID “001” in FIG. 8(a), information of the operation date and time, user information, a simple caption and a life log as well are displayed.

More specifically, the life log presentation control unit 18, based on information of the operation date and time and user information (Mr. XXX) that are acquired from the life log acquisition unit 17s, displays a life log caption “Following is the life log of Mr. XXX on 20 Jan. 2010”, a life log that is an e-mail text message that is transmitted to the operation party (Mr. XXX) “How are you? Here somehow doing fine . . . ” on the life log display area LR of the display unit 11a.

As above, the mobile phone 10s that is a content execution device of the second embodiment retains the operation history information HJ with the operation party to whom the processing of the content is executed, and the caption that is a description substance of the content that is generated corresponding to the presentation of the operation history information HJ at the start of process of the content is confirmed to a user, along with this, the life log that is generated corresponding to the operation history information HJ during the processing execution of the content. In this manner, the mobile phone 10s, compared to the mobile phone 10 that is the content processing execution device of the first embodiment, makes it possible to moderately promote communication with the party by reminding a party who is an operation subject person for the content more visually or aurally with high frequency.

### Third Embodiment

### 5. Configuration of Mobile Phone 10t of the Third Embodiment

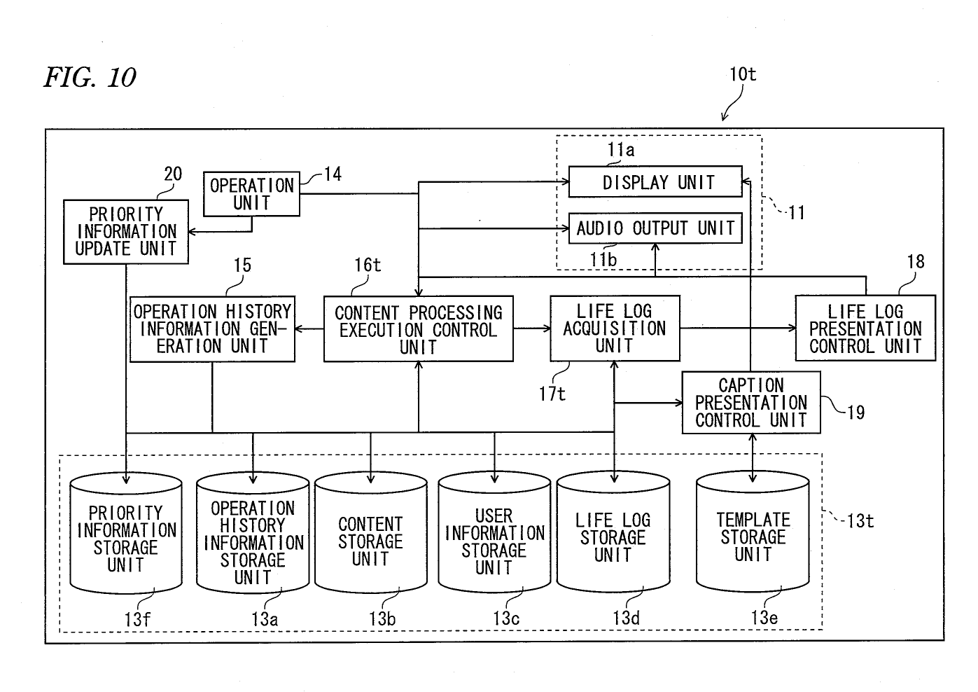

FIG. 10 is a block diagram showing the internal configuration of a mobile phone 10t of the third embodiment. As shown in FIG. 10, the mobile phone 10t includes a presentation unit 11, a storage unit 13, an operation unit 14, an operation history information generation unit 15, a content processing execution control unit 16t, a life log acquisition unit 17t, a life log presentation control unit 18, a caption presentation control unit 19, and a priority information update unit 20. The mobile phone 10t of the third embodiment further includes the priority information update unit 20 in the mobile phone 10s of the second embodiment, and the same reference numerals are attached to common parts with FIG. 1 or FIG. 6 and a detailed description thereof will be omitted and description will be mainly made of differing parts.

In the third embodiment, the content processing execution control unit 16, in a case where a plurality of operation history information HJ is stored in an operation history information storage unit 13a based on a content ID, selects single operation history information HJ used in preference out of the plurality of the operation history information HJ. A life log and a caption corresponding to selected operation history information HJ are presented to the presentation unit 11.

The storage unit 13t includes an operation history information storage unit 13a, a content storage unit 13b, a user information storage unit 13c, a life log storage unit 13d, a template storage unit 13e, and a priority information memory unit 13f. Since the operation history information storage unit 13a, the content storage unit 13b, the user information storage unit 13c, the life log storage unit 13d, and the priority information memory unit 13f are the same as what is included in the storage unit 13s of the second embodiment, a description that is related to the same units will be omitted, and the priority information storage unit 13f will be described.

In the priority information storage unit 13f, based on the content ID included in an operation signal in which the content processing execution control unit 16t is output by the operation unit 14, priority information is stored, which is for selecting specific operation history information HJ used in preference out of plurality of operation history information HJ that is acquired as a result of searching an operation history information storage unit 13a. The priority information, for example, is information that an operation date and time of the content chooses the oldest operation history information HJ out of the plurality of operation history information HJ. Further, the priority information may also be the information in which the priority order selected according to an operation substance of the content is prescribed. For example, in the priority information in this case, an operation substance “to have transmitted an e-mail with an attached file” is the highest prioritized, and an operation substance “to have received an e-mail with an attached file” is the second prioritized information or the like, in a case where the operation history information HJ including the highest prioritized operation substance is acquired from the operation history information storage unit 13a, the content processing execution control unit 16t selects a specific operation history information HJ including the highest prioritized operation substance based on the priority information. Further, in a case where the operation history information HJ including the highest operation substance is selected in plural numbers, each operation date of the plurality of the operation history information HJ may be the priority information that selects the oldest operation history information HJ.

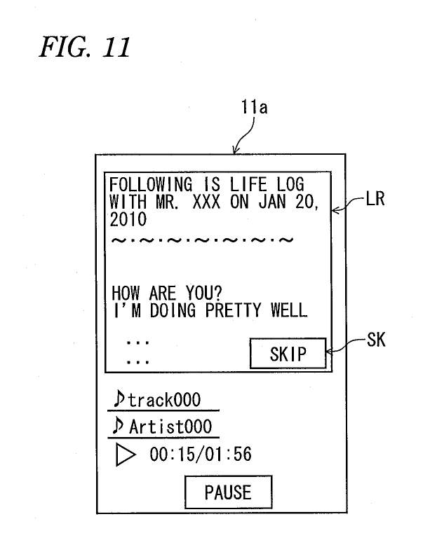

Further, in the priority information storage unit 13f, in a case where a skip button SK that is displayed on the life log display area LR of FIG. 11 is pressed down by a user operating the operation unit 14, acquisition exclusion information is stored in order for the life log acquisition unit 17t to exclude a life log that is displayed at the time of being pressed down from an acquisition subject of a subsequent life log storage unit 13d. FIG. 11 is an explanatory diagram showing a brief summary of operation of the mobile phone 10t of the third embodiment, along with the life log, the skip button SK is displayed on the life log display area LR. The skip button SK is prescribed so as to be displayed in the operation of the content processing execution control unit 16t or the life log presentation control unit 18, such that it is preferable to display in conjunction with the skip button SK especially when the life log presentation control unit 18 displays the life log on the display unit 11a. In the acquisition exclusion information, for example, a life log ID that is an indicator of the life log of the acquisition exclusion target is included. Therefore, in a case where the skip button SK is pressed down, the priority information update unit 20 acquires the operation signal of being pressed from the operation unit 14, along with this, the life log ID of the life log that is displayed in response to press-down of the skip button SK stores so as to include the acquisition exclusion information.

Further, in the acquisition exclusion information, furthermore, such as a keyword that the user feels uncomfortable may also be included. For example, when the life log acquisition unit 17t searches the life log storage unit 13d based on the acquisition exclusion information that is stored in the priority information storage unit 13f, the life log including the keyword information may also be excluded from the acquisition target. Further, it may be preferable that such as the keyword included in the acquisition exclusion information can be properly changed by the user operating the operation unit 14.

The priority information update unit 20 is configured by such as a CPU, a DSP, a ROM, and a RAM, and updates automatically the priority information or the acquisition exclusion information that is stored in the priority information storage unit 13f with a predetermined period that is prescribed in advance in the operation of the priority information update unit 20. For example, in a case where the predetermined period is a month, the priority information update unit 20 updates priority information or acquisition exclusion information on a monthly basis, and can make a contribution to select the operation history information in accordance with a user's preference. In addition, even if not being updated automatically, the priority information or the acquisition exclusion information that is stored in the priority information storage unit 13f may also be updated manually by the user operating the operation unit 14.

### 6. Description for Operation of Mobile Phone 10t of the Third Embodiment

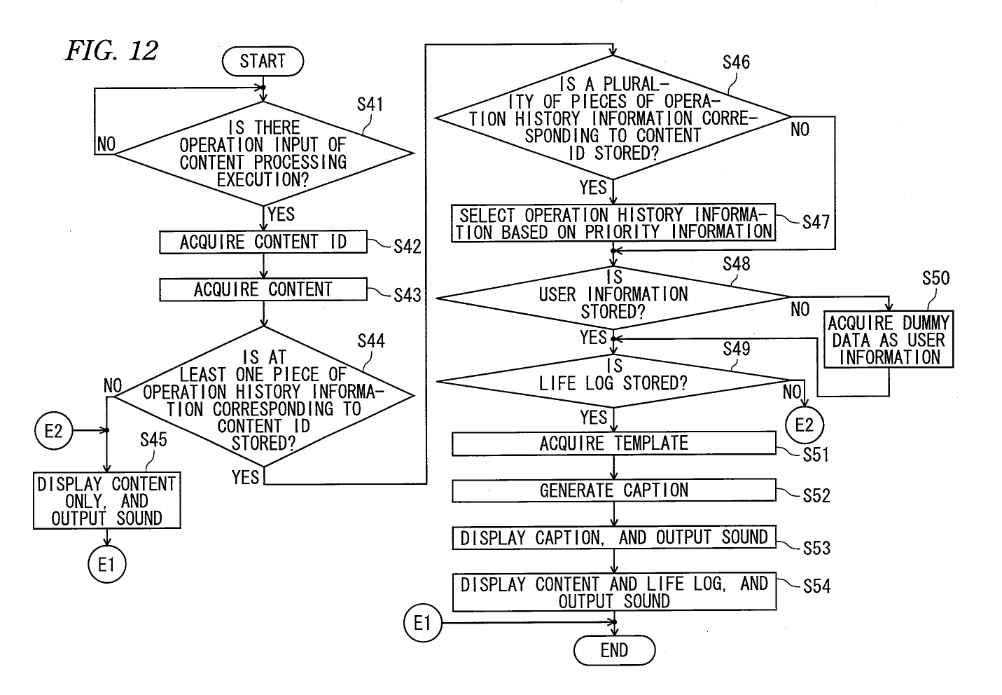

The operation of the mobile phone 10t of the third embodiment will be described by referring to FIGS. 8 and 12. FIG. 12 is a flowchart describing an operation of the mobile phone 10t of the third embodiment. Hereinafter, in FIG. 12, the operation history information HJ of which the content is music data, acquired by the content processing execution control unit 16 is described as being the operation history information HJ for the content ID “001” shown in FIG. 2.

In FIG. 12, the operation substance from a step S41 to a step S43 is overlapped with the operation substance from a step S21 to a step S23 of the operation substance for the mobile phone 10s of the second embodiment shown in FIG. 9. Therefore, a description of the operation substance from the step S41 to the step S43 is omitted. However, the operation substance from the step S41 to the step S43 can be described to the extent that is feasible by replacing it with the operation substance from the step S11 to the step S13 which is the operation substance of the corresponding mobile phone 10 of the first embodiment.

The content processing execution control unit 16t searches the operation history information storage unit 13a based on the content ID that is acquired by step S42, and determines whether or not at least one operation history information HJ corresponding to the content ID is stored in the operation history information storage unit 13a (S44).

In a case where the operation history information HJ corresponding to the content ID is acquired by the step S42 is determined not to be stored in the operation history information storage unit 13a (S44, NO), the content processing execution control unit 16t performs control so as to present the content that is acquired by the step S43 to the presentation unit 11 (S45), and then the flowchart of FIG. 12 is completed. That is, in the step S45, the content processing execution control unit 16t, in a case where the content that is acquired by the step S13 is music data, performs control so as to play back the content that is the music data and cause the music data to be output as a sound to the audio output unit 11b.

In case where at least one operation history information HJ corresponding to the content ID that is acquired by the step S42 is determined to be stored in the operation history information storage unit 13a (S44,YES), the content processing execution control unit 16t determines whether or not the acquired operation history information HJ is plural number (S46).

In the step S46, in a case where the operation history information HJ that is acquired is determined to be plural number, the content processing execution control unit 16t refers to and acquires the priority information that is stored in the priority information storage unit 13f, selects single operation history information HJ used in preference based on the acquired priority information (S47), and proceeds to the operation of step S48.

In the step S46, in a case where the acquired operation history information HJ is determined to be single, not being plural (S45, NO), then the process proceeds to the operation of the step S48.

The operation substance from the step S48 to the step S54 is overlapped with the operation substance from a step S26 to the step S32 that is the operation substance for the mobile phone 10s of the second embodiment shown in FIG. 9. Therefore, a description of the operation substance from the step S48 to the step S54 is omitted. However, the operation substance from the step S48 to the step S54 can be described to the extent that is feasible by replacing it with the operation substance from the step S26 to the step S32 that is the operation substance of corresponding the mobile phone 10s of the second embodiment.

As above, the mobile phone 10t that is the content processing execution device of the third embodiment, in a case where the operation history information HJ with the operation party to whom the processing of the content is executed is acquired in plural number, selects single operation history information HJ used in preference based on the priority information that is stored in the priority information storage unit 13f. In the mobile phone 10 or the mobile phone 10s of the first or second embodiment, in a case where the life log corresponding to all of the plural operation history information HJ is to be presented to the presentation unit 11, there is a possibility that it will take a considerable time to present all of the life log, and there is a possibility that it will be difficult for the user to enjoy the content. According to the mobile phone 10t of the third embodiment, compared to the mobile phone 10 or the mobile phone 10s of the first or second embodiment, in a case where the life log corresponding to all of the plural operation history information HJ is presented to the presentation unit 11, by extremely shortening the time that the life log is presented, it is possible to prevent for the user to feel unpleasant, or for the remembrance of memory to be disturbed to the contrary.

### Fourth Embodiment

### 7. Configuration of Mobile Phone 10f of the Fourth Embodiment

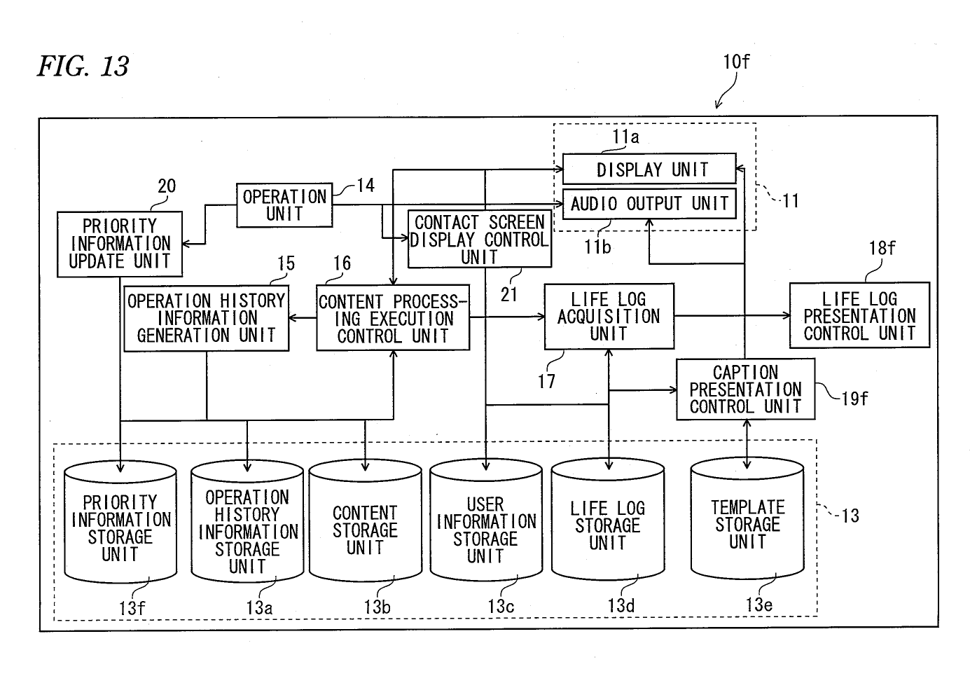

FIG. 13 is a block diagram showing the internal configuration of a mobile phone 10f of the fourth embodiment. As shown in FIG. 13, the mobile phone 10f includes a presentation unit 11, a storage unit 13, an operation unit 14, an operation history information generation unit 15, a content processing execution control unit 16, a life log acquisition unit 17, a life log presentation control unit 18f, a caption presentation control unit 19f, a priority information update unit 20, and a contact screen display control unit 21. The mobile phone 10f of the fourth embodiment further includes the contact screen display control unit 21 in the mobile phone 10t of the third embodiment, and the same reference numerals are attached to common parts with FIG. 1, FIG. 6 or FIG. 10 and a detailed description thereof will be omitted and description will be mainly made of differing parts.

In the fourth embodiment, when information of the operation date and time, the user information, and the life log that are acquired from the life log acquisition unit 17 are displayed on the display unit 11a, in conjunction with which, the life log presentation control unit 18f displays also an e-mail button MB and a telephone button TB that are contact buttons prompting the start-up display of a contact screen to contact with respect to the party corresponding to the user information (FIGS. 14(a), 4(b) and FIGS. 15(a), 15(b)).

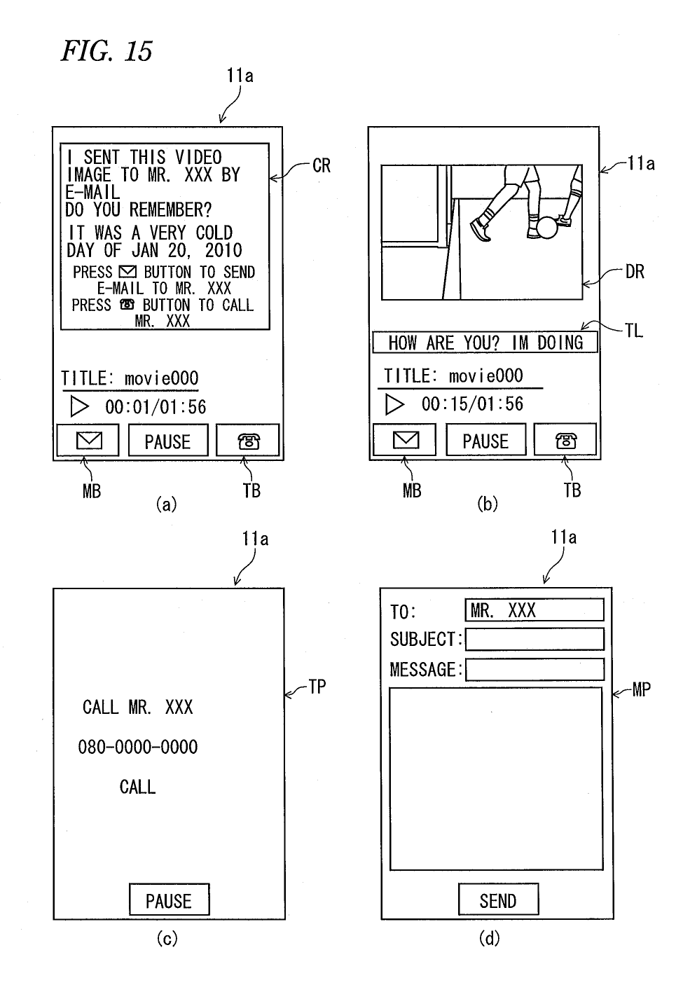

In the same manner, the caption presentation control unit 19f, when a caption generated based on each piece of information of the operation date and time and the operation substance, the template data, and the user information as well that are output by the life log acquisition unit 17 is displayed on the display unit 11a, in conjunction with which, the e-mail button MB and the telephone button TB that are the same contact buttons may also be displayed (refer to FIGS. 4(a), 4(b) and FIGS. 15(a), 15(b)).

The contact screen display control unit 21 is configured of such as a CPU, a DSP, a ROM, and a RAM that are built in the mobile phone 10f, in a case where the operation signal to the effect that the each contact button that is displayed on display unit 11a by the life log presentation control unit 18 or the caption presentation control unit 19 is pressed down is acquired from the operation unit 14, displays the contact screen in accordance with the contact button being pressed down on the display unit 11a. The operation signal includes the type of e-mail button MB or the type of telephone button TB that is the contact button.

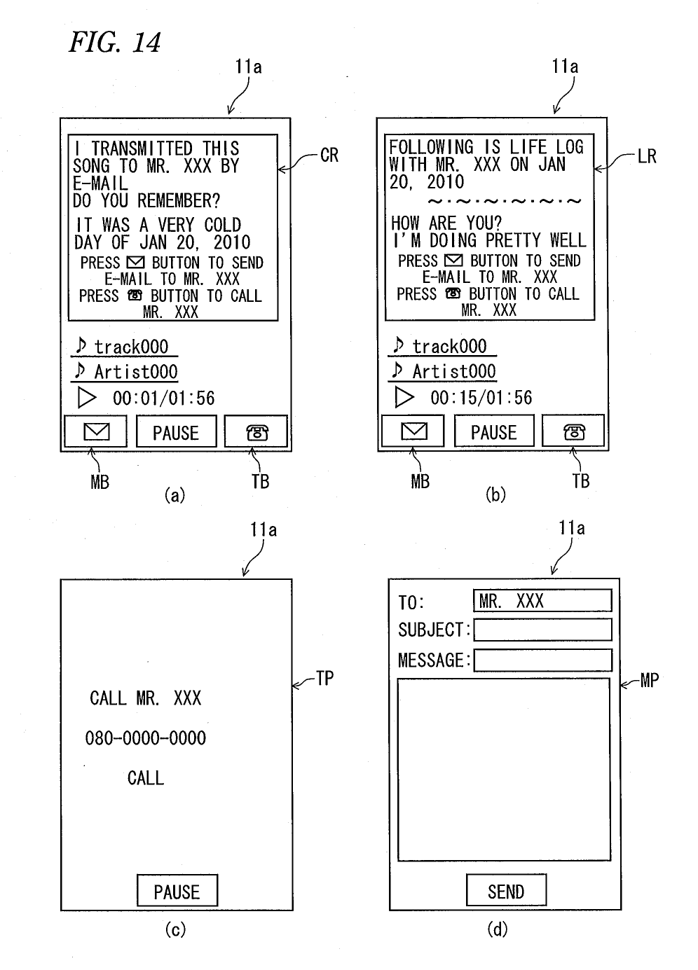

For example, in a case where the e-mail button MB as the contact button is pressed down, the contact screen display control unit 21, based on the user information of the operation party corresponding to the life log or the caption that is displayed at the time of being pressed down, the contact screen MP (refer to FIG. 14(d)) to transmit an e-mail to the operation party is displayed. The contact screen MP, based on the user information of the operation party, is displayed in a state where an e-mail address is input to the destination, it may be preferable that an e-mail can be directly transmitted from the contact screen MP. Further, in a case where the telephone button TB as the contact button is pressed down, the contact screen display control unit 21, based on the user information of the operation party corresponding to the life log or the caption that is displayed at the time of being pressed down, displays the contact screen TP (refer to FIG. 14(c)) to call the operation party. The contact screen TP, based on the user information of the operation party, is displayed in a state where a telephone number is displayed, it may be preferable that a direct call can be made from the contact screen display TP.

### 8. Description for Operation of Mobile Phone 10f of the Fourth Embodiment

The operation of the mobile phone 10f of the fourth embodiment will be described by referring to FIGS. 14 to 16. The FIG. 14 is an explanatory diagram showing a brief summary of operation of the mobile phone 10f of the fourth embodiment. FIG. 14(a) is an explanatory diagram showing an exemplary caption that is displayed on the display unit 11a. FIG. 14(b) is an explanatory diagram showing an exemplary caption and life log that are displayed on the display unit 11a. FIG. 14(c) is an explanatory diagram showing an exemplary contact screen TP. FIG. 14(d) is an explanatory diagram showing an exemplary contact screen MP.

FIG. 15 is an explanatory diagram showing a brief summary of operation of the mobile phone 10f of the fourth embodiment. FIG. 15(a) is an explanatory diagram showing an exemplary caption that is displayed on the display unit 11a. FIG. 15(b) is an explanatory diagram showing exemplary caption and life log that are displayed on the display unit 11a. FIG. 15(c) is an explanatory diagram showing an exemplary contact screen TP. FIG. 15(d) is an explanatory diagram showing an exemplary contact screen MP.

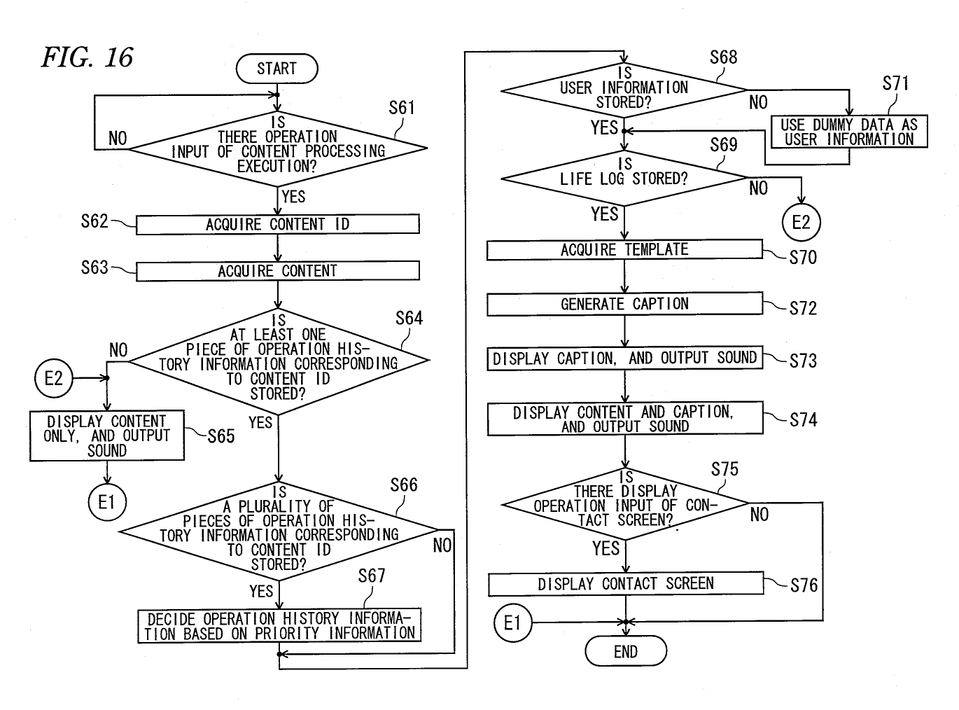

FIG. 16 is a flowchart describing an operation of the mobile phone 10f of the fourth embodiment. Hereinafter, in FIG. 14 to FIG. 16, the operation history information HJ of which the content is music data, acquired by the content processing execution control unit 16 is described as being the operation history information HJ with respect to the content ID “001” shown in FIG. 2.

In FIG. 16, the operation substance from a step S61 to step S72 is overlapped with the operation substance from the step S41 to the step S52 that is operation substance for the mobile phone 10t of the third embodiment shown in FIG. 12. Therefore, a description of the operation substance from the step S61 to the step S72 is omitted. However, the operation substance from the step S61 to the step S72 can be described to the extent that is feasible by replacing it with the operation substance from the step S41 to the step S52 that is the operation substance of corresponding mobile phone 10t of the third embodiment.

In step S73, the caption presentation control unit 19f, when the processing of the content that the content processing execution control unit 16 acquires from the content storage unit 13b is started to execute, performs control so as to cause the caption generated by the step S72 to be displayed on the display unit 11. Alternatively, the caption presentation control unit 19f performs control so as to cause the substance of the generated caption to be output as a sound on the audio output unit 11b. Furthermore, the caption presentation control unit 19f, when each piece of information of the operation date and time and the operation substance, the template data, and the user information that are output by the life log acquisition unit 17 is displayed on the display unit 11a, in conjunction with which, the e-mail button MB and the telephone button TB that are the contact buttons prompting the start-up display of a contact screen of a contact screen TP or a contact screen MP to contact with respect to the party corresponding to the user information may be displayed (refer to FIG. 14(a) and FIG. 15(a)). Furthermore, it may be preferable that the caption presentation control unit 19f displays a supplementary description for performing a start-up display on the contact screen TP or the contact screen MP on a caption area CR. Through this supplementary description, the user can quickly confirm the substances of the e-mail button MB and the telephone button TB that are displayed.

After the caption according to the step S73 being presented by the presentation unit 11, the life log presentation control unit 18f acquires the information of the operation date and time, the user information and the life log that are output by the life log acquisition unit 17. The life log presentation control unit 18f, while the content processing control unit 16 executes the content processing of that is acquired from the content storage unit 13b, controls so as to present the acquired information of the operation date and time, the user information, and the life log to the presentation unit 11 (S74). That is, the life log presentation control unit 18f performs control so as to cause the acquired information of the operation date and time, the user information and the life log to be displayed on the display unit 11a.

For example, as shown in FIG. 14(b), in the life log display area LR of the display unit 11a, based on the operation history information HJ of “track 000” that is a selected content ID “001” in FIG. 8(a), information of the operation date and time and user information, and the life log as well are displayed.

More specifically, the life log presentation control unit 18f, based on the information of the operation date and time and the user information (Mr. XXX) that are acquired from the life log acquisition unit 17, displays a life log caption “Following is the life log of Mr. XXX on 2010 Jan. 20”, a life log that is an e-mail text message that is transmitted to the life log (Mr. XXX) “How are you? Here somehow doing fine . . . ”, and the supplementary description for performing a start-up display on the contact screen TP or the contact screen MP that is described above on the life log display area LR of the display unit 11a. Furthermore, the life log presentation control unit 18f displays the supplementary description for performing the start-up display on the contact screen TP or the contact screen MP on the life log display area LR of the display unit 11a.

Further, for example, as shown in FIG. 15(b), in a case where the content is video data, the content processing execution control unit 16 plays and displays the video data that is the content in the content display area DR of the display unit 11a, and the life log presentation control unit 18 may also display the life log in ticker TL format in the life log display area LR of the display unit 11a. In this manner, by the user identifying the substance of the life log that is displayed as the ticker TL while identifying the play substance of the content, the probability that the user being more clearly reminded of the operation party with respect to the content more clearly is improved, and it is possible to promote the communication with the party.

After the operation of step S74, the contact screen display control unit 21 determines whether or not the operation signal to the effect that the e-mail button MB or telephone button TB that is a contact button displayed in the display unit 11a is pressed down is acquired from the operation unit 14 (S75). In case where the operation signal is determined to be acquired by the operation unit 14 (S75, YES), the contact screen display control unit 21 displays the contact screen corresponding to the type of the contact button including the operation signal that is acquired by the operation unit 14 on the display unit 11a (S76).

As above, the mobile phone 10f of the fourth embodiment retains the operation history information HJ with the operation party to whom the processing of the content is executed, and the presentation of the life log and the caption corresponding to the operation history information HJ during the processing execution of the content is confirmed to the user. Furthermore, the mobile phone 10f also presents to the user the contact button to contact a party who is an operation subject person corresponding to the presented life log. In this manner, the mobile phone 10 visually or aurally reminds of a party who is an operation subject person for the content of the user, and causes the contact screen corresponding to the press-down of the contact button to be displayed on the display unit 11a, in such a manner that it is possible to plan the promotion of a communication with the party with high frequency.

As above, various types of embodiments have been described while referring to the attached drawings. However, it goes without saying that the content processing execution device, the content processing execution method and the programme of the present invention are not limited to such examples. In the category as described in the claims, it may be apparent for those skilled in the art to come up with examples of modification or change of various embodiments, furthermore combined examples of the various embodiments, for which also are understood as belonging to the technical scope of the present invention.

For example, the life log presentation control unit 18 of the mobile phone 10 of the first embodiment described above, corresponding to information of an operation substance that is output by the life log acquisition unit 17 as shown in FIG. 4(b), generates so as to include the information of the operation out of the substance of the caption, and which may also be presented to the presentation unit 11. In this case, as the same as the caption template of the second embodiment, the caption template in accordance with the information of the operation substance is stored in advance in the storage unit 13. The life log presentation control unit 18 refers to the stored caption template, and generates a caption, such that it is preferred for the life log presentation control unit 18 to present in such a manner.

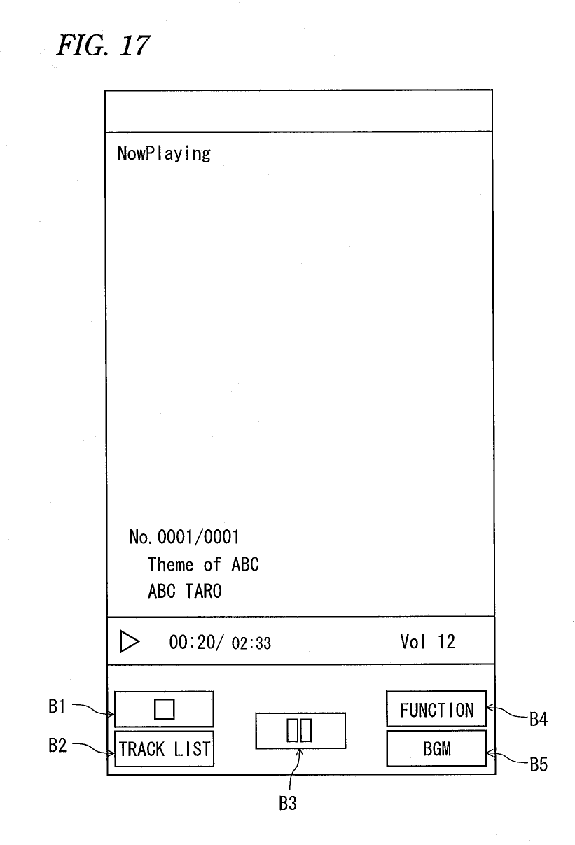

FIG. 17 is an explanatory diagram showing an exemplary screen that various types of button are displayed on the display unit of the conventional mobile phone. As an example of the fourth embodiment described above, in a case where the content is music data, in the screen of the application for the content play shown in FIG. 17, the life log presentation control unit 18 and the caption presentation control unit 19, for example, instead of a song list button B2 and a BGM button B5, it may also be controlled so as to display each of the e-mail button MB and the telephone button TB that are the contact buttons described above. In this case, the display function of the song list and the BGM play function executed by pressing down the song list button B2 and the BGM button B5 may be included as a part of a function menu list that is displayed by pressing down a function button B4.

Further, as a modified example of the fourth embodiment described above, in a case where content is music data, in the screen of the application for the content play shown in FIG. 17, the life log presentation control unit 18 and the caption presentation control unit 19, for example, out of a stop button B1, the song list button B2, a pause button B3, a function button B4 and the BGM button B5, for example, may also control so as to include the e-mail button MB and the telephone button TB that are the contact buttons described above into a plurality of menus included in the function button B4 to be able to perform a start-up display.

Further, as a modified example of the fourth embodiment described above, in a case where content is music data, the life log presentation control unit 18 and the caption presentation control unit 19 display the e-mail button MB and the telephone button TB that are the contact buttons in response to the press-down of any one of each button of the mobile phone 10f having a predetermined numeric keypad, such that it may be preferable that a relationship between the contact button and each button is prescribed in advance in the operation of the life log presentation control unit 18 and the caption presentation control unit 19.

In addition, in each embodiment, mobile phones 10, 10s, 10t and 10f are described as examples. However, the mobile terminal of the present invention is not limited to the mobile phones 10, 10s, 10t and 10f for example, is also able to be broadly applied to electronic devices such as a PC (Personal Computer) or a PDA.

In addition, the present application is based on the Japanese patent application filed on Jun. 15, 2010 (Application No. 2010-136617), the substances thereof are incorporated by being referred herein.

### INDUSTRIAL APPLICABILITY

The present invention is useful as a content processing execution device, a content processing execution method, and a programme to plan a promotion of communication with the party by recalling a party that is an operation subject, the processing of which is executed using a content.

### DESCRIPTION OF REFERENCE SIGNS

10, 10f, 10s, 10t: MOBILE PHONE

11: PRESENTATION UNIT

11a: DISPLAY UNIT

11b: AUDIO OUTPUT UNIT

13: STORAGE UNIT

13a: OPERATION HISTORY INFORMATION STORAGE UNIT

13b: CONTENT STORAGE UNIT

13c: USER INFORMATION MEMORY UNIT

13d: LIFE LOG STORAGE UNIT

13e: TEMPLATE STORAGE UNIT

13f: PRIORITY INFORMATION STORAGE UNIT

14: OPERATION UNIT

15: OPERATION HISTORY INFORMATION GENERATION UNIT

16: CONTENT PROCESSING EXECUTION CONTROL UNIT

17: LIFE LOG ACQUISITION UNIT

18: LIFE LOG PRESENTATION CONTROL UNIT

19: CAPTION PRESENTATION CONTROL UNIT

20: PRIORITY INFORMATION UPDATE UNIT

21: CONTACT SCREEN DISPLAY CONTROL UNIT

BP, TP: CONTACT SCREEN

CR: CAPTION DISPLAY AREA

CT: TEMPLATE MANAGEMENT INFORMATION

DR: CONTENT DISPLAY AREA

HJ: OPERATION HISTORY INFORMATION

LR: LIFE LOG DISPLAY AREA

LT: LIFE LOG MANAGEMENT INFORMATION

MB: EMAIL BUTTON

SK: SKIP BUTTON

TB: TELEPHONE BUTTON

TL: TICKER

1. A content processing execution device comprising:
an operation history information storage unit that stores operation history information associated with an operation date and time of a content, an operation substance of the content and an operation party of the content;
a life log storage unit that stores a life log corresponding to the operation substance of the operation history information of the content;
a content processing execution control unit that acquires operation history information corresponding to the content from the operation history information storage unit in accordance with an instruction of a processing execution of input content;
a life log acquisition unit that acquires the life log corresponding to the operation substance of the operation history information from the life log storage unit based on the operation history information that is acquired by the content processing execution control unit; and
a life log presentation control unit that performs control so as to present the life log acquired by the life log acquisition unit when the processing of the content is executed.

2. The content processing execution device according to claim 1,
wherein the life log acquisition unit acquires a life log corresponding to the operation party of the operation history information, and
wherein after a presentation of the life log corresponding to the acquired operation substance by the life log acquisition unit, the life log presentation control unit performs control so as to present the life log corresponding to the operation party acquired by the life log acquisition unit.

3. The content processing execution device according to claim 1, further comprising a presentation unit that presents the life log that is controlled to be presented by the life log presentation control unit.

4. The content processing execution device according to claim 3,
wherein the presentation unit is a display unit that displays the life log, and
wherein the life log presentation control unit performs control such that the life log is displayed on the display unit.

5. The content processing execution device according to claim 3,
wherein the presentation unit is an audio output unit that outputs the life log as a sound, and
wherein the life log presentation control unit performs control such that the audio output unit outputs the life log as the sound.

6. The content processing execution device according to claim 1, further comprising a user information storage unit that stores user information of the operation party of the operation history information,
wherein the life log acquisition unit acquires the user information of the operation party of the operation history information from the user information storage unit.

7. The content processing execution device according to claim 6, further comprising:
a template storage unit that stores template data in which a template of a caption that is a description substance of the life log is determined in accordance with the operation substance of the operation history information; and
a caption presentation control unit that generates the caption based on the template data in accordance with the operation substance of the operation history information from the template storage unit, the life log and the user information that are acquired by the life log acquisition unit.

8. The content processing execution device according to claim 1, further comprising a priority information storage unit that stores priority information of the operation history information,
wherein in a case where the content processing execution control unit acquires a plurality of pieces of the operation history information in accordance with the instruction of processing execution of the input content, the content processing execution control unit selects specific piece of the operation history information from the plurality of pieces of the operation history information based on the priority information.

9. The content processing execution device according to claim 8, further comprising a presentation unit that presents the life log that is controlled to be presented by the life log presentation control unit.

10. The content processing execution device according to claim 9, further comprising a user information storage unit that stores user information of the operation party of the operation history information,
wherein in accordance with an instruction to contact the operation party acquired by the user information storage unit, the content processing execution control unit performs control such that a contact screen including user information of the operation party acquired by the user information storage unit is displayed on a display unit as the presentation unit.

11. The content processing execution device according to claim 1, further comprising an operation history information generation unit that generates operation history information associated with the operation date and time, the operation substance and the operation party of the content when the processing of the content is executed,
wherein the operation history information generation unit stores the operation information that is generated in the operation history information storage unit.

12. A content processing execution method comprising:
receiving an instruction of a processing execution of content;
acquiring operation history information of the content corresponding to the instruction from an operation history information storage unit that stores operation history information associated with an operation date and time of the content, an operation substance of the content, and an operation party of the content in accordance with the instruction of processing execution of the input content;
acquiring a life log corresponding to the operation substance of the operation history information from a life log storage unit that stores a life log corresponding to an operation substance of operation history information of the content based on the acquired operation history information; and
presenting the acquired life log when the processing of the content is executed.

13. A non-transitory computer readable storage medium storing one or more programs, said one or more programs comprising instructions, which when executed by a content processing execution device, cause the content processing execution device to:
receive an instruction of a processing execution of content;
acquire operation history information of the content corresponding to the instruction from an operation history information storage unit that stores operation history information associated with an operation date and time of the content, an operation substance of the content, and an operation party of the content in accordance with the instruction of processing execution of the input content;
acquire a life log corresponding to the operation substance of the operation history information from a life log storage unit that stores a life log corresponding to an operation substance of operation history information of the content based on the acquired operation history information; and
present the acquired life log when the processing of the content is executed.
